(19) United States
(12) Patent Application Publication
(10) Pub. No.: US 2025/0390984 A1
(43) Pub. Date: Dec. 25, 2025

(54) PICTURE DISPLAY METHOD, SYSTEM, DEVICE, AND COMPUTER-READABLE STORAGE MEDIUM

(71) Applicant: ARASHI VISION INC., Shenzhen (CN)

(72) Inventors: Longxiang MA, Shenzhen (CN); Weijun ZHANG, Shenzhen (CN); Jun HOU, Shenzhen (CN)

(73) Assignee: ARASHI VISION INC., Shenzhen (CN)

(21) Appl. No.: 19/308,178

(22) Filed: Aug. 22, 2025

Related U.S. Application Data
(63) Continuation of application No. PCT/CN2024/077912, filed on Feb. 21, 2024.

(30) Foreign Application Priority Data
Feb. 23, 2023 (CN) 202310190774.4

(51) Int. Cl. G06T 3/4038; G06T 5/73; G06T 7/20; G06T 7/70; H04N 23/61; H04N 23/63; H04N 23/698

(52) U.S. Cl. CPC G06T 3/4038; G06T 5/73; G06T 7/20; G06T 7/70; H04N 23/61; H04N 23/632; H04N 23/698; G06T 2200/24; G06T 2207/20028; G06T 2207/20092

(57) ABSTRACT

In some aspects, a method for displaying a picture is provided. A first panoramic picture is acquired, and a to-be-displayed picture region and a target picture region are determined in the first panoramic picture. The target picture region can be mapped to a target planar sub-window. Target recognition may be performed on the target planar sub-window. In response to determining that a target object is recognized, the target object can be placed at a preset position in the target planar sub-window. The to-be-displayed picture region and the target planar sub-window can be displayed on a target display interface.

### CROSS-REFERENCE TO RELATED APPLICATION

This application is a continuation of International Application No. PCT/CN2024/077912, filed on Feb. 21, 2024, which claims the benefit of priority to Chinese Patent Application No. 202310190774.4, filed on Feb. 23, 2023. The entire contents of these applications are hereby incorporated by reference in their entireties.

### BACKGROUND

The present disclosure relates to the technical field of image display, and more specifically, to a picture display method, system, device, and computer-readable storage medium.

Panorama, also known as 3D real scene, is an emerging rich media technology. Its biggest difference from traditional streaming media such as video, audio, and images is that it is “operable and interactive.” With panoramic technology, users can view a target object from all directions. However, in application scenarios such as panoramic video conferencing, shooting, and live video streaming, there is a type of user demand to highlight the main subject in the picture. For example, when the user is within an effective recognition region, the user's viewpoint is tracked to determine the user's target viewpoint, and based on this target viewpoint and viewpoint range, a target image region is determined in the panoramic video's spherical coordinate system, and the target image region is highlighted.

However, in the above methods for displaying panoramic images, since the recognition region is a sphere and there is the distortion of the target object on the sphere, the features of people are unclear, the accuracy of target recognition is low, and the directly displayed panoramic picture has distortion and poor visual effect.

In summary, when displaying panoramic images, how to improve the accuracy of target recognition and enhance the visual effect of picture display is a problem that those skilled in the art urgently need to solve.

### SUMMARY

The purpose of the present disclosure is to provide a picture display method, which can, to a certain extent, solve the technical problems of low target recognition accuracy and poor visual effect when displaying panoramic images. The present disclosure also provides a picture display system, device, and computer-readable storage medium.

To achieve the above purpose, the present disclosure provides the following technical solutions.

A picture display method, including:
acquiring a first panoramic picture;
determining a to-be-displayed picture region and a target picture region in the first panoramic picture;
mapping the target picture region to a target planar sub-window;
performing target recognition on the target planar sub-window, and if a target object is recognized, placing the target object at a preset position in the target planar sub-window; and
displaying the to-be-displayed picture region and the target planar sub-window on a target display interface.

In some embodiments, after the target object is recognized, the method further includes:
determining first position information of the target object in the first panoramic picture;
determining second position information of the target object in a to-be-displayed panoramic picture, the to-be-displayed panoramic picture including a panoramic picture to be displayed after the first panoramic picture; and
if the first position information and the second position information do not meet a preset condition, adjusting the target picture region of the to-be-displayed panoramic picture, so that the target object is located in the target picture region of the to-be-displayed panoramic picture.

In some embodiments, adjusting the target picture region of the to-be-displayed panoramic picture, so that the target object is located in the target picture region of the to-be-displayed panoramic picture, includes:
determining a positional offset of the target object between the first panoramic picture and the to-be-displayed panoramic picture based on the first position information and the second position information; and
sliding and adjusting the target picture region of the to-be-displayed panoramic picture based on the positional offset, so that the target object is located in the target picture region of the to-be-displayed panoramic picture.

In some embodiments, adjusting the target picture region of the to-be-displayed panoramic picture, so that the target object is located in the target picture region of the to-be-displayed panoramic picture, includes:
determining an angle offset of the target object between the first panoramic picture and the to-be-displayed panoramic picture based on the first position information and the second position information; and
rotating and adjusting the target picture region of the to-be-displayed panoramic picture based on the angle offset, so that the target object is located in the target picture region of the to-be-displayed panoramic picture.

In some embodiments, determining the second position information of the target object in the to-be-displayed panoramic picture includes:
performing target tracking on the target object based on the first position information to obtain the second position information of the target object in the to-be-displayed panoramic picture.

In some embodiments, after displaying the to-be-displayed picture region and the target planar sub-window on the target display interface, the method further includes:
receiving adjustment information of the target planar sub-window from a user; and
adjusting a position of the target planar sub-window on the target display interface and/or a size of the target planar sub-window and/or a shape of the target planar sub-window based on the adjustment information.

In some embodiments, after displaying the to-be-displayed picture region and the target planar sub-window on the target display interface, the method further includes:
enhancing a display effect of the target object in the target planar sub-window.

A picture display system, including:
an acquiring module, configured to acquire a first panoramic picture;
a determining module, configured to determine a to-be-displayed picture region and a target picture region in the first panoramic picture;
a mapping module, configured to map the target picture region of the first panoramic picture to a target planar sub-window;
a recognizing module, configured to perform target recognition on the target planar sub-window, and if a target object is recognized, place the target object at a preset position in the target planar sub-window; and
a displaying module, configured to display the to-be-displayed picture region and the target planar sub-window on a target display interface.

A picture display device, including:
a memory, configured to store a computer program; and
a processor, configured to implement the operations of any of the above panoramic picture display methods when executing the computer program.

A computer-readable storage medium, the computer-readable storage medium storing a computer program, the computer program, when executed by a processor, implementing the operations of any of the above picture display methods.

The picture display method provided in the present disclosure includes: acquiring a first panoramic picture; determining a to-be-displayed picture region and a target picture region in the first panoramic picture; mapping the target picture region to a target planar sub-window; performing target recognition on the target planar sub-window, and if a target object is recognized, placing the target object at a preset position in the target planar sub-window; and displaying the to-be-displayed picture region and the target planar sub-window on a target display interface. In the present disclosure, the target picture region of the first panoramic picture can be mapped to a planar sub-window, and while displaying the to-be-displayed picture region, the target object can be placed at a preset position in the target planar sub-window for display, thereby realizing planar display of the target object in the first panoramic picture by means of the target planar sub-window, avoiding distortion of the target object caused by panoramic display, improving the accuracy of target recognition during panoramic image display, enhancing the visual effect during panoramic image display, and providing good applicability of the method. The panoramic picture display system, device, and computer-readable storage medium provided in the present disclosure also solve the corresponding technical problems.

### BRIEF DESCRIPTION OF DRAWINGS

In order to more clearly illustrate the technical solutions in the embodiments of the present disclosure or the related art, the drawings required for the description of the embodiments or the related art will be briefly introduced below. Obviously, the drawings described below are only some embodiments of the present disclosure. For those skilled in the art, other drawings can also be obtained based on the provided drawings without creative efforts.

FIG. 1 is a first flowchart of a picture display method according to some embodiments of the present disclosure.

FIG. 2 is a schematic diagram of a real-time panoramic picture and a target planar sub-window according to some embodiments of the present disclosure.

FIG. 3 is a second flowchart of a picture display method according to some embodiments of the present disclosure.

FIG. 4 is a schematic structural diagram of a picture display system according to some embodiments of the present disclosure.

FIG. 5 is a schematic structural diagram of a picture display device according to some embodiments of the present disclosure.

FIG. 6 is another schematic structural diagram of a picture display device according to some embodiments of the present disclosure.

The present disclosure will be described with reference to the accompanying drawings.

### DETAILED DESCRIPTION

The following will provide a clear and complete description of the technical solutions in the embodiments of the present disclosure with reference to the accompanying drawings in the embodiments of the present disclosure. Obviously, the described embodiments are only a part of the embodiments of the present disclosure, and not all embodiments. Based on the embodiments in the present disclosure, all other embodiments obtained by those of ordinary skill in the art without creative efforts shall fall within the protection scope of the present disclosure.

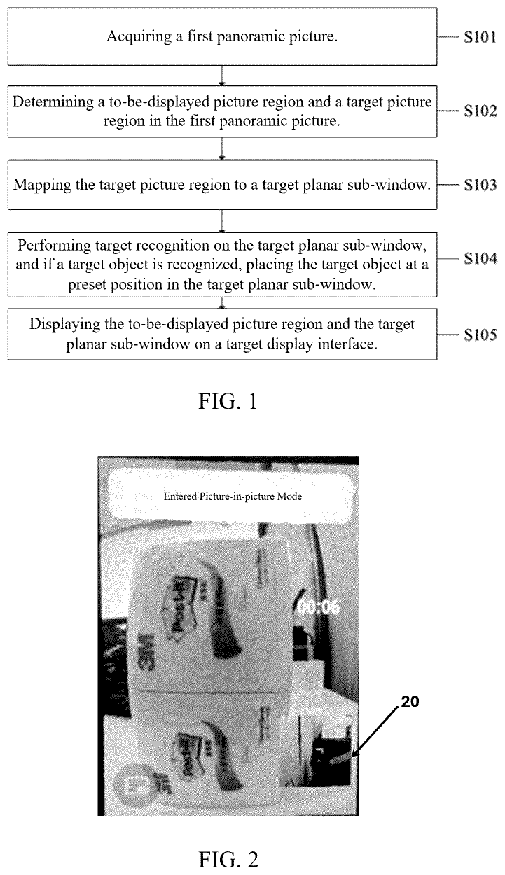

Please refer to FIG. 1, which is a first flowchart of a method for displaying a picture provided according to some embodiments of the present disclosure.

A method for displaying a picture according to some embodiments of the present disclosure may include several operations as follows:

S101: Acquiring a first panoramic picture.

In some embodiments, the first panoramic picture may be acquired first, so as to display the first panoramic picture subsequently. It should be noted that the first panoramic picture may be the current panoramic picture to be displayed in a panoramic picture video stream, and the content of the first panoramic picture may be determined based on specific application scenarios. For example, the first panoramic picture may be a panoramic picture generated during a video communication process, or a panoramic picture generated by photographing buildings, vehicles, etc. In addition, the first panoramic picture may be a panoramic picture used for real-time panoramic display, or a panoramic picture used for post-processing panoramic display, etc. The present disclosure is not specifically limited to this.

S102: Determining a to-be-displayed picture region and a target picture region in the first panoramic picture.

In some embodiments, after acquiring the first panoramic picture, the to-be-displayed picture region and the target picture region in the first panoramic picture may be determined, respectively, so as to display of the content in the to-be-displayed picture region and the target picture region subsequently.

In the context, the term “target picture region” may refer to a portion of the panoramic image from the first panoramic picture that contains the target object of interest, which is mapped to a target planar sub-window for focused display and recognition. In contrast, the term “to-be-displayed picture region” may refer to a general area of the panoramic image intended for display on the display interface, providing a broader scene context.

In some application scenarios, the to-be-displayed picture region and the target picture region in the first panoramic picture may be determined based on the user's display requirements. For example, a picture selection instruction from a user may be received, and the to-be-displayed picture region and the target picture region in the first panoramic picture may be determined based on the picture selection instruction. In some examples, the picture selection instruction may be a dragging instruction. In the process of determining the to-be-displayed picture region and the target picture region according to the dragging instruction, a random portion of the first panoramic picture may be displayed to the user first. Subsequently, the user's dragging instruction may be received, and the first panoramic picture is dragged based on the dragging instruction, such as dragging up and down, left and right, etc. When the dragging ends, the picture finally displayed to the user is the to-be-displayed picture region, the target picture region, or both. It should be noted that, in this process, a zoom-in or zoom-out instruction for the first panoramic picture from the user may also be received, and the picture displayed to the user may be zoomed in or out according to the zoom-in or zoom-out instruction, so that the determined to-be-displayed picture region and target picture region can meet the picture size requirements set by the user.

It should be noted that the pictures in the to-be-displayed picture region and the target picture region are all panoramic pictures, and the size, shape, and position in the first panoramic picture of the to-be-displayed picture region and the target picture region may be determined based on actual needs. For ease of understanding, specific examples are given here, which do not accordingly limit the scope of the present disclosure. Suppose the first panoramic picture is a panoramic picture generated during a video lecture using a mobile device, then the target picture region may be the panoramic picture in the first panoramic picture that contains all the lecture content or the current lecture content, and the to-be-displayed picture region may be the panoramic picture containing the upper body or the whole body of the lecturer. The shape of the to-be-displayed picture region may be circular, and the shape of the target picture region may be rectangular, etc.

S103: Mapping the target picture region to a target planar sub-window.

In some embodiments, after determining the to-be-displayed picture region and the target picture region in the first panoramic picture, the target picture region may be mapped to a target planar sub-window, so as to display the panoramic picture in the target picture region in a planar manner using the target planar sub-window subsequently.

It should be noted that the shape, size, and position of the target planar sub-window may be determined based on actual needs. For example, the target planar sub-window may be square, rectangular, circular, etc. The size of the target planar sub-window may be 200*100, 300*300, etc. The target planar sub-window may be located at the lower left corner, center, upper right corner, lower right corner, etc. of the display interface, as shown in FIG. 2, where the sub-window at the lower right corner of the screen is a target planar sub-window 20. The present disclosure is not specifically limited to this example with the specific size, locations, shape, etc. To some extent, the difference between the target picture region and the to-be-displayed picture region may lie in their function and focus within the panoramic image.

In some embodiments, in the process of mapping the target picture region to the target planar sub-window, the target picture region may first be mapped to a spherical coordinate system to obtain a spherical coordinate mapping result. Subsequently, the center position and size information of the target planar sub-window may be determined. Accordingly, based on the center position, size information, and preset FOV (Field of View), the spherical coordinate mapping result may be quickly projected to the target planar sub-window.

S104: Performing target recognition on the target planar sub-window, and if a target object is recognized, placing the target object at a preset position in the target planar sub-window.

In some embodiments, after mapping the target picture region to the target planar sub-window, target recognition may be performed on the target planar sub-window. In response to determining that a target object is recognized, the target object may be placed at a preset position in the target planar sub-window for display, for example, displaying the target object at the center position of the target planar sub-window.

The term “placing the target object at a preset position” may be used to refer to the process of adjusting the spatial coordinates of the recognized target object within the target planar sub-window, such that the target object is visually aligned with a predefined reference location, e.g., the center of the sub-window. This operation may involve translating or adjusting the viewport or cropping parameters to ensure the target object appears at the designated position within the sub-window.

It should be noted that, in some application scenarios, the user may adjust the shooting position and/or the shooting angle, and/or rotate the panoramic camera, so that the target object is placed in the target planar sub-window. In other words, at least one operation of adjusting shooting position, adjusting shooting, or rotating the panoramic camera may be performed by the user. The panoramic camera may be a camera that provides the first panoramic picture.

As such, the target object can be recognized in the target planar sub-window. It can be understood that in some scenarios, the user may manually adjust the camera to ensure that the target object will appear within the target planar sub-window, facilitating the target recognition. This “placing” adjustment here is different from the “placing” operation described after the target recognition which may refer to a system-level adjustment that repositions the recognized target object within the sub-window in order to optimize visual consistency and user experience.

In other examples, when the target object cannot be recognized in the target planar sub-window, a preview picture (e.g., real-time sensor feed) may be displayed in the target planar sub-window, etc. The present disclosure, however, is not specifically limited to this example.

It should also be noted that, in some application scenarios, target recognition may be performed on the target object by using parts of the target object with obvious features. For example, when the target object is a person, the target object may be recognized according to the face, head, body, head, and shoulders, etc. Correspondingly, the target planar sub-window may focus on displaying the parts of the target object with obvious features.

In addition, in the process of recognizing the target object, for example, a threshold segmentation method may be used to segment the target object in the picture and locate the target object region by using the difference between the pixels of the target object region and the background region. Alternatively, a detector based on convolutional neural network technology (such as YOLO, SSD, R-CNN, RetinaFace, MTCNN, etc.) may be used to detect and locate the target object, or traditional feature-based detection algorithms such as Haar, FHOG, etc. may be used to extract features in the image and match them with the features of the target object to locate the position of the target object, etc. The present disclosure is not specifically limited to these examples.

S105: Displaying the to-be-displayed picture region and the target planar sub-window on a target display interface.

In some embodiments, after placing the target object at a preset position in the target planar sub-window, the to-be-displayed picture region and the target planar sub-window may be displayed on the target display interface. For example, when the target display interface is a single display interface (e.g., a unified screen or display area), the to-be-displayed picture region may be displayed in the center (i.e., center of the to-be-displayed picture region in the display), and the target planar sub-window may be displayed at the lower right corner or upper right corner of the target display interface, so as to display the to-be-displayed picture region and the target planar sub-window on the target display interface in a picture-in-picture mode. In some examples, the to-be-displayed picture region may also be displayed on the left half of the target display interface, and the target planar sub-window may be displayed on the right half of the target display interface, so as to display the to-be-displayed picture region and the target planar sub-window on the target display interface in a split-screen mode, etc. In some examples, when the target display interface includes two display interfaces, the to-be-displayed picture region and the target planar sub-window may be displayed on the two display interfaces respectively. It should be noted that, since the to-be-displayed picture region is essentially a panoramic picture, the displayed to-be-displayed picture region may include a curved or other non-planar picture.

In some embodiments, after displaying the to-be-displayed picture region and the target planar sub-window on the target display interface, in order to ensure that the display of the target planar sub-window can meet the user's requirements, adjustment information of the target planar sub-window from the user may also be received. Based on the adjustment information, the position of the target planar sub-window on the target display interface and/or the size of the target planar sub-window and/or the shape of the target planar sub-window may be adjusted.

In some embodiments, after displaying the to-be-displayed picture region and the target planar sub-window on the target display interface, in order to ensure the display quality of the picture in the target planar sub-window, display effect enhancement processing may also be performed on the target object in the target planar sub-window. For example, sharpening processing may be performed on the target object in the target planar sub-window to make the picture content clearer, and/or bilateral filtering may be performed on the target object in the target planar sub-window to provide a certain beautification effect, etc.

In some aspects of the present disclosure, the method for displaying a picture may include: acquiring a first panoramic picture; determining a to-be-displayed picture region and a target picture region in the first panoramic picture; mapping the target picture region to a target planar sub-window; performing target recognition on the target planar sub-window, and if a target object is recognized, placing the target object at a preset position in the target planar sub-window; and displaying the to-be-displayed picture region and the target planar sub-window on a target display interface, as shown in FIG. 1.

In the present disclosure, the target picture region of the first panoramic picture may be mapped to a planar sub-window, and while displaying the to-be-displayed picture region, the target object may be placed at a preset position in the target planar sub-window for display, thereby realizing planar display of the target object in the first panoramic picture through the target planar sub-window. As a result, it can avoid distortion of the target object caused by panoramic display, improve the accuracy of target recognition during panoramic image display, enhance the visual effect during panoramic image display, and provide good applicability of the method.

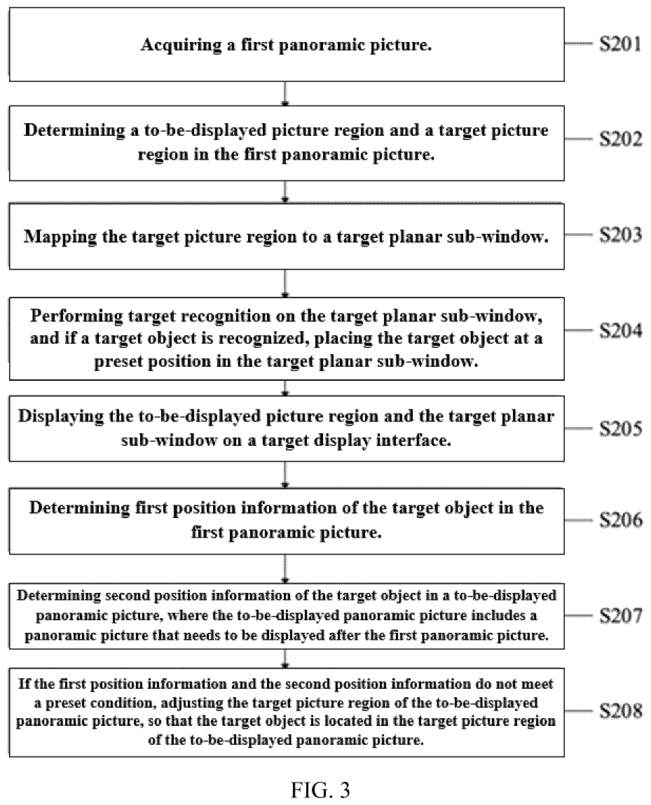

Please refer to FIG. 3, which is a second flowchart of a method for displaying a picture according to some embodiments of the present disclosure.

Another method for displaying a picture according to some embodiments of the present disclosure may include:

S201: Acquiring a first panoramic picture.

S202: Determining a to-be-displayed picture region and a target picture region in the first panoramic picture.

S203: Mapping the target picture region to a target planar sub-window.

S204: Performing target recognition on the target planar sub-window. When a target object is recognized, placing the target object at a preset position in the target planar sub-window.

S205: Displaying the to-be-displayed picture region and the target planar sub-window on a target display interface.

S206: Determining first position information of the target object in the first panoramic picture.

S207: Determining second position information of the target object in a to-be-displayed panoramic picture, where the to-be-displayed panoramic picture may include a panoramic picture to be displayed after the first panoramic picture.

S208: If the first position information and the second position information do not meet a preset condition, adjusting the target picture region of the to-be-displayed panoramic picture, so that the target object is located in the target picture region of the to-be-displayed panoramic picture.

In some embodiments, considering that the position of the target object may change in two adjacent panoramic pictures, in order to continuously display the target object in two consecutive frames of panoramic pictures in the target planar sub-window, after recognizing the target object, first position information of the target object in the first panoramic picture may be determined; second position information of the target object in the to-be-displayed panoramic picture may be determined. The to-be-displayed panoramic picture may include a panoramic picture to be displayed after the first panoramic picture. In response to determining that the first position information and the second position information do not meet a preset condition, the target picture region of the to-be-displayed panoramic picture may be adjusted, so that the target object is located in the target picture region of the to-be-displayed panoramic picture.

In some examples, the term “preset condition” may refer to whether the target object remains at a fixed relative position (such as the center) within the target picture region across consecutive panoramic pictures, and can be considered not met if the target object shifts beyond an acceptable range, such as from the center to a corner, resulting in potential visual fluctuation.

In this way, when displaying the to-be-displayed panoramic picture, by mapping the target picture region of the to-be-displayed panoramic picture to the target planar sub-window using the method of the present disclosure, it can be ensured that the target object is always mapped to the target planar sub-window (when the target recognition is successful), and the target object can be quickly displayed by the target planar sub-window. That is, the present disclosure can adjust the target picture region in the to-be-displayed panoramic picture according to the position change information of the target object between the first panoramic picture and the to-be-displayed panoramic picture, so as to quickly display the target object in the to-be-displayed panoramic picture.

In some application scenarios, in the process of adjusting the target picture region of the to-be-displayed panoramic picture so that the target object is located in the target picture region of the to-be-displayed panoramic picture, a sliding window method may be used to determine the target picture region of the to-be-displayed panoramic picture. That is, based on the first position information and the second position information, a positional offset of the target object between the first panoramic picture and the to-be-displayed panoramic picture may be determined. Based on the positional offset, the target picture region of the to-be-displayed panoramic picture may be slid and adjusted, so that the target object is located in the target picture region of the to-be-displayed panoramic picture.

For ease of understanding, certain examples are given here. Suppose the target object is placed at the center position of a target planar sub-window with a size of (128*128). After the target position is updated, the position of the target object in the first panoramic picture and the to-be-displayed panoramic picture changes. If it is necessary to ensure that the target is still at the center of the target planar sub-window, the position of the target picture region corresponding to the target planar sub-window may be adjusted according to the positional offset of the target object between the first panoramic picture and the to-be-displayed panoramic picture, so as to obtain the target picture region of the next frame containing the target object. Suppose the target picture region is a rectangular box, after determining the positional offset of the target object between the first panoramic picture and the to-be-displayed panoramic picture based on the first position information and the second position information, the rectangular box in the first panoramic picture may be slid according to the positional offset with the center of the rectangular box in the first panoramic picture as the reference, so as to obtain the rectangular box in the to-be-displayed panoramic picture, that is, to obtain the target picture region in the to-be-displayed panoramic picture.

In some application scenarios, in the process of adjusting the target picture region of the to-be-displayed panoramic picture so that the target object is located in the target picture region of the to-be-displayed panoramic picture, a rotation method may be used to determine the target picture region of the to-be-displayed panoramic picture. That is, based on the first position information and the second position information, an angle offset of the target object between the first panoramic picture and the to-be-displayed panoramic picture may be determined. Based on the angle offset, the target picture region of the to-be-displayed panoramic picture may be rotated and adjusted, so that the target object is located in the target picture region of the to-be-displayed panoramic picture.

For ease of understanding, certain examples are provided here. Suppose the target object is placed at the center position of a target planar sub-window with a size of (128*128). The target picture region corresponding to the target planar sub-window may be rotated according to the angle offset of the target object between the first panoramic picture and the to-be-displayed panoramic picture, so as to ensure that the target object coincides with the center of the target planar sub-window, thereby ensuring that the target object is located in the target picture region of the to-be-displayed panoramic picture. Still suppose the target picture region is a rectangular box, after determining the angle offset of the target object between the first panoramic picture and the to-be-displayed panoramic picture based on the first position information and the second position information, the rectangular box in the first panoramic picture may be rotated according to the angle offset with the center of the rectangular box in the first panoramic picture as the reference, so as to obtain the rectangular box in the to-be-displayed panoramic picture, that is, to obtain the target picture region in the to-be-displayed panoramic picture.

It should be noted that, whether it is the sliding window method or the rotation method, both can be understood as continuously sliding the target picture region corresponding to the target planar sub-window on the panoramic picture with the target object as the center. In addition, it should be noted that, in the sliding window method or the rotation method, in the process of adjusting the target picture region of the to-be-displayed panoramic picture, if the target object in the first panoramic picture is at the center of the target picture region, and the target object in the to-be-displayed panoramic picture is at the upper left corner of the target picture region, then after mapping the target picture region to the target planar sub-window in the same way, suppose the target object in the first panoramic picture is at the center of the target planar sub-window, then the target object in the to-be-displayed panoramic picture will be at the upper left corner of the target planar sub-window. In this case, there will be a display fluctuation problem of the target object in the target planar sub-window. In order to avoid this problem, it is necessary to ensure that the position of the target object in the target planar sub-window is fixed. At this time, the target picture region of the to-be-displayed panoramic picture may be adjusted according to the principle that the position of the target object in the target picture region is fixed, so as to avoid the display fluctuation problem caused by adjusting the target picture region and improve the user experience.

For ease of understanding, certain examples are provided here. Suppose that the target picture region is a rectangular box, and the target object in the first panoramic picture is at the center of the rectangular box, then after adjusting the rectangular box, it is still necessary to ensure that the target object in the to-be-displayed panoramic picture is still at the center of the rectangular box.

In some application scenarios, in the process of determining the second position information of the target object in the to-be-displayed panoramic picture, target tracking may be performed on the target object in the to-be-displayed panoramic picture based on the first position information, so as to obtain the second position information of the target object in the to-be-displayed panoramic picture. In some examples, the picture region corresponding to the first position information may be determined in the to-be-displayed panoramic picture first, and then target tracking may be performed on the target object based on the picture region, so as to obtain the second position information of the target object in the to-be-displayed panoramic picture. Compared with directly querying the corresponding second position information of the target object in the to-be-displayed panoramic picture, this embodiment can quickly track the second position information of the target object in the to-be-displayed panoramic picture based on the first position information.

In some application scenarios, in the process of performing target tracking on the target object, a feature matching method may be used, such as region matching, feature point tracking, etc. First, the features of the target object are extracted, and then the most similar features are found in subsequent frames to locate the target object; or a search-based method may be used, such as a correlation filtering algorithm, where a filtering template is designed, and the template is correlated with the candidate region of the target, and the position of the target object is continuously updated according to the peak position of the correlation coefficient; or a deep learning-based method may be used, such as a Siamese Region Proposal Network (SiamRPN), where the initial frame template features of the target object are extracted, and in subsequent frames, the region most similar to the initial frame features is continuously searched to complete the position update of the target object; or a target detection-based method may be used, such as a target tracking detection algorithm, where the position of the target object is detected in each frame, and then according to certain matching rules, the target objects belonging to the same position are linked together to ensure that the target object at that position in the past period of time belongs to the same target object. The matching rules may include the following two types: (1) matching the center coordinates of the target detection box, setting a matching threshold thr, the distance between the center coordinates of the detection box in the k^{th} frame and the (k-i)^{th} frame is set as d, if d<thr, the two detection boxes are considered to be successfully matched, if d>=thr, the two boxes are considered to be unrelated; and (2) matching the IOU of the target detection box, setting a matching threshold thr, the distance metric of the detection box in the kth frame and the (k-i)^{th} frame is IOU (Intersection over Union), if IOU>thr, the two detection boxes are considered to be successfully matched, if IOU<=thr, the two boxes are considered to be unrelated, etc. In this way, cross-frame tracking of the target object, etc. can be quickly performed.

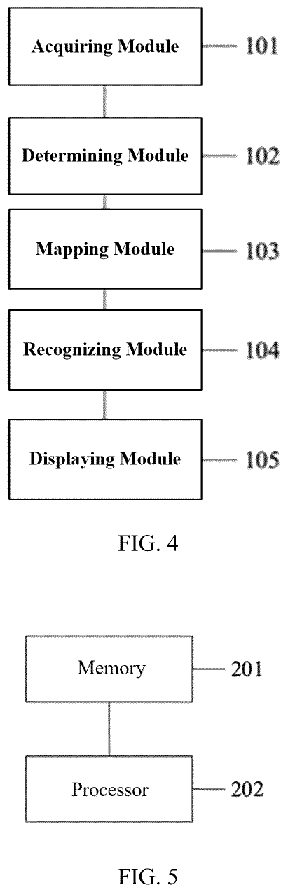

Please refer to FIG. 4, which is a schematic structural diagram of a picture display system according to some embodiments of the present disclosure.

As shown in FIG. 4, the picture display system according to some embodiments of the present disclosure may include:
an acquiring module 101, configured to acquire a first panoramic picture;
a determining module 102, configured to determine a to-be-displayed picture region and a target picture region in the first panoramic picture;
a mapping module 103, configured to map the target picture region of the first panoramic picture to a target planar sub-window;
a recognizing module 104, configured to perform target recognition on the target planar sub-window, and if a target object is recognized, place the target object at a preset position in the target planar sub-window; and
a displaying module 105, configured to display the to-be-displayed picture region and the target planar sub-window on a target display interface.

In some embodiments, the acquiring module 101, the determining module 102, the mapping module 103, the recognizing module 104, and the displaying module 105 can be implemented using software, hardware, firmware, or any suitable combination thereof. These modules can be operably coupled or integrated to collaboratively execute the operations described in accordance with the embodiments of the present disclosure. In some examples, a first panoramic picture is acquired, and a to-be-displayed picture region and a target picture region are determined in the first panoramic picture. The target picture region can be mapped to a target planar sub-window. Target recognition may be performed on the target planar sub-window. In response to determining that a target object is recognized, the target object can be placed at a preset position in the target planar sub-window. The to-be-displayed picture region and the target planar sub-window can be displayed on a target display interface.

In a picture display system according to some embodiments of the present disclosure, the recognizing module may also be, e.g., configured to: after a target object is recognized, determine first position information of the target object in the first panoramic picture; determine second position information of the target object in a to-be-displayed panoramic picture, where the to-be-displayed panoramic picture includes a panoramic picture to be displayed after the first panoramic picture. If the first position information and the second position information do not meet a preset condition, adjust the target picture region of the to-be-displayed panoramic picture, so that the target object is located in the target picture region of the to-be-displayed panoramic picture.

In a picture display system according to some embodiments of the present disclosure, the recognizing module may also be, e.g., configured to: determine a positional offset of the target object between the first panoramic picture and the to-be-displayed panoramic picture based on the first position information and the second position information; and slide and adjust the target picture region of the to-be-displayed panoramic picture based on the positional offset, so that the target object is located in the target picture region of the to-be-displayed panoramic picture.

In a picture display system according to some embodiments of the present disclosure, the recognizing module may also be, e.g., configured to: determine an angle offset of the target object between the first panoramic picture and the to-be-displayed panoramic picture based on the first position information and the second position information; and rotate and adjust the target picture region of the to-be-displayed panoramic picture based on the angle offset, so that the target object is located in the target picture region of the to-be-displayed panoramic picture.

In a panoramic picture display system according to some embodiments of the present disclosure, the recognizing module may also be, e.g., configured to: perform target tracking on the target object based on the first position information to obtain the second position information of the target object in the to-be-displayed panoramic picture.

A picture display system according to some embodiments of the present disclosure may further include:
a receiving module, configured to, after the displaying module displays the to-be-displayed picture region and the target planar sub-window on the target display interface, receive adjustment information of the target planar sub-window from a user; and
an adjusting module, configured to, based on the adjustment information, adjust a position of the target planar sub-window on the target display interface and/or a size of the target planar sub-window and/or a shape of the target planar sub-window.

A panoramic picture display system according to some embodiments of the present disclosure may further include:
an enhancing module, configured to, after the displaying module displays the to-be-displayed picture region and the target planar sub-window on the target display interface, perform display effect enhancement processing on the target object in the target planar sub-window.

The present disclosure also provides a picture display device and a computer-readable storage medium, both of which have the corresponding effects of the panoramic picture display method according to some embodiments of the present disclosure. Please refer to FIG. 5, which is a schematic structural diagram of a panoramic picture display device according to some embodiments of the present disclosure.

A picture display device according to some embodiments of the present disclosure includes a memory 201 and a processor 202 coupled to the memory 201. The memory 201 stores a computer program (e.g., computer instructions), and the processor 202 implements the following operations when executing the computer program:
acquiring a first panoramic picture;
determining a to-be-displayed picture region and a target picture region in the first panoramic picture;
mapping the target picture region to a target planar sub-window;
performing target recognition on the target planar sub-window, and if a target object is recognized, placing the target object at a preset position in the target planar sub-window; and
displaying the to-be-displayed picture region and the target planar sub-window on a target display interface.

A picture display device according to some embodiments of the present disclosure includes a memory 201 and a processor 202. The memory 201 stores a computer program or computer instructions, and the processor 202 implements the following operations when executing the computer program/computer instructions: after a target object is recognized, determining first position information of the target object in the first panoramic picture; determining second position information of the target object in a to-be-displayed panoramic picture, where the to-be-displayed panoramic picture includes a panoramic picture to be displayed after the first panoramic picture. If the first position information and the second position information do not meet a preset condition, adjusting the target picture region of the to-be-displayed panoramic picture, so that the target object is located in the target picture region of the to-be-displayed panoramic picture.

A picture display device according to some embodiments of the present disclosure includes a memory 201 and a processor 202. The memory 201 stores a computer program/computer instructions, and the processor 202 implements the following operations when executing the computer program/computer instructions: determining a positional offset of the target object between the first panoramic picture and the to-be-displayed panoramic picture based on the first position information and the second position information; and sliding and adjusting the target picture region of the to-be-displayed panoramic picture based on the positional offset, so that the target object is located in the target picture region of the to-be-displayed panoramic picture.

A picture display device according to some embodiments of the present disclosure includes a memory 201 and a processor 202. The memory 201 stores a computer program/computer instructions, and the processor 202 implements the following operations when executing the computer program/computer instructions: determining an angle offset of the target object between the first panoramic picture and the to-be-displayed panoramic picture based on the first position information and the second position information; and rotating and adjusting the target picture region of the to-be-displayed panoramic picture based on the angle offset, so that the target object is located in the target picture region of the to-be-displayed panoramic picture.

A picture display device according to some embodiments of the present disclosure includes a memory 201 and a processor 202. The memory 201 stores a computer program/computer instructions, and the processor 202 implements the following operations when executing the computer program/computer instructions: performing target tracking on the target object based on the first position information to obtain the second position information of the target object in the to-be-displayed panoramic picture.

A picture display device according to some embodiments of the present disclosure includes a memory 201 and a processor 202. The memory 201 stores a computer program/computer instructions, and the processor 202 implements the following operations when executing the computer program/computer instructions: after displaying the to-be-displayed picture region and the target planar sub-window on the target display interface, receiving adjustment information of the target planar sub-window from a user; and based on the adjustment information, adjusting a position of the target planar sub-window on the target display interface and/or a size of the target planar sub-window and/or a shape of the target planar sub-window.

A picture display device according to some embodiments of the present disclosure includes a memory 201 and a processor 202. The memory 201 stores a computer program/computer instructions, and the processor 202 implements the following operations when executing the computer program/computer instructions: after displaying the to-be-displayed picture region and the target planar sub-window on the target display interface, performing display effect enhancement processing on the target object in the target planar sub-window.

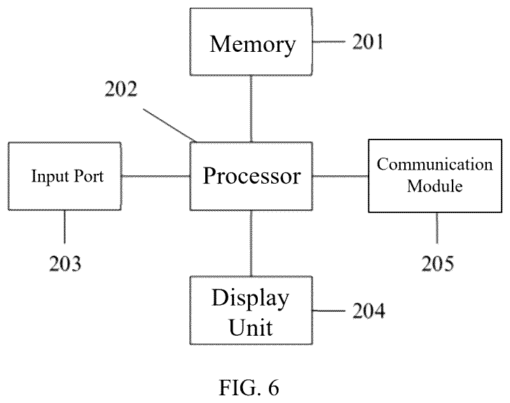

Please refer to FIG. 6. Another picture display device according to some embodiments of the present disclosure may further include: an input port 203 connected/coupled to the processor 202, configured to transmit external input commands to the processor 202; a display unit 204 connected/coupled to the processor 202, configured to display the processing result of the processor 202 to the outside; and a communication module 205 connected/coupled to the processor 202, configured to realize communication between the panoramic picture display device and the outside.

In some examples, the input port 203 may be configured to receive commands or instructions directed to the picture display device. These may include, for instance, a user's picture selection instruction or a dragging operation performed by the user to adjust the display content.

In addition, the communication module 205 may be configured to enable the picture display device to communicate with an external device. This facilitates data exchange or synchronization between the picture display device and other components or systems, enhancing interoperability and system flexibility.

The display unit 204 described herein and the target display interface described earlier may be substantially equivalent in the contexts. The display unit 204 may be a display panel, a laser scanning display, etc.; and the communication mode adopted by the communication module 205 includes but is not limited to Mobile High-Definition Link (MHL), Universal Serial Bus (USB), High-Definition Multimedia Interface (HDMI), wireless connection: WiFi, Bluetooth communication technology, low-power Bluetooth communication technology, communication technology based on IEEE802.11s.

A computer-readable storage medium according to some embodiments of the present disclosure stores a computer program/computer instructions, and the computer program/computer instructions, when executed by a processor, implements the following operations:
acquiring a first panoramic picture;
determining a to-be-displayed picture region and a target picture region in the first panoramic picture;
mapping the target picture region to a target planar sub-window;
performing target recognition on the target planar sub-window, and if a target object is recognized, placing the target object at a preset position in the target planar sub-window; and
displaying the to-be-displayed picture region and the target planar sub-window on a target display interface.

A computer-readable storage medium according to some embodiments of the present disclosure stores a computer program/computer instructions, and the computer program/computer instructions, when executed by a processor, implement(s) the following operations: after a target object is recognized, determining first position information of the target object in the first panoramic picture; determining second position information of the target object in a to-be-displayed panoramic picture, where the to-be-displayed panoramic picture includes a panoramic picture to be displayed after the first panoramic picture. If the first position information and the second position information do not meet a preset condition, adjusting the target picture region of the to-be-displayed panoramic picture, so that the target object is located in the target picture region of the to-be-displayed panoramic picture.

A computer-readable storage medium according to some embodiments of the present disclosure stores a computer program/computer instructions, and the computer program/computer instructions, when executed by a processor, implement(s) the following operations: determining a positional offset of the target object between the first panoramic picture and the to-be-displayed panoramic picture based on the first position information and the second position information; and sliding and adjusting the target picture region of the to-be-displayed panoramic picture based on the positional offset, so that the target object is located in the target picture region of the to-be-displayed panoramic picture.

A computer-readable storage medium according to some embodiments of the present disclosure stores a computer program/computer instructions, and the computer program/computer instructions, when executed by a processor, implement(s) the following operations: determining an angle offset of the target object between the first panoramic picture and the to-be-displayed panoramic picture based on the first position information and the second position information; and rotating and adjusting the target picture region of the to-be-displayed panoramic picture based on the angle offset, so that the target object is located in the target picture region of the to-be-displayed panoramic picture.

A computer-readable storage medium according to some embodiments of the present disclosure stores a computer program/computer instructions, and the computer program/computer instructions, when executed by a processor, implement(s) the following operations: performing target tracking on the target object based on the first position information to obtain the second position information of the target object in the to-be-displayed panoramic picture.

A computer-readable storage medium according to some embodiments of the present disclosure stores a computer program/computer instructions, and the computer program/computer instructions, when executed by a processor, implement(s) the following operations: after displaying the to-be-displayed picture region and the target planar sub-window on the target display interface, receiving adjustment information of the target planar sub-window from a user; and based on the adjustment information, adjusting a position of the target planar sub-window on the target display interface and/or a size of the target planar sub-window and/or a shape of the target planar sub-window.

A computer-readable storage medium according to some embodiments of the present disclosure stores a computer program/computer instructions, and the computer program/computer instructions, when executed by a processor, implement(s) the following operations: after displaying the to-be-displayed picture region and the target planar sub-window on the target display interface, performing display effect enhancement processing on the target object in the target planar sub-window.

The computer-readable storage medium involved in the present disclosure includes random access memory (RAM), memory, read-only memory (ROM), electrically programmable ROM, electrically erasable programmable ROM, registers, hard disks, removable disks, CD-ROMs, or any other form of storage medium known in the art.

For the description of the relevant parts of the picture display system, device, and computer-readable storage medium according to some embodiments of the present disclosure, please refer to the detailed description of the corresponding parts in the panoramic picture display method according to some embodiments of the present disclosure, which will not be repeated here. In addition, the parts of the above technical solutions according to some embodiments of the present disclosure that are consistent with the implementation principles of the corresponding technical solutions in the related art are not described in detail, so as to avoid excessive repetition.

It should also be noted that, in this document, relational terms such as first and second are only used to distinguish one entity or operation from another entity or operation, and do not necessarily require or imply any such actual relationship or order between these entities or operations. Moreover, the terms “include,” “contain,” or any other variants thereof are intended to cover non-exclusive inclusion, so that a process, method, article, or device that includes a series of elements not only includes those elements, but also includes other elements not explicitly listed, or further includes elements inherent to such process, method, article, or device. Without further limitation, an element defined by the phrase “include a . . . ” does not exclude the presence of additional identical elements in the process, method, article, or device that includes the element.

The above description of the disclosed embodiments enables those skilled in the art to implement or use the present disclosure. Various modifications to these embodiments will be apparent to those skilled in the art, and the general principles defined herein may be implemented in other embodiments without departing from the spirit or scope of the present disclosure. Therefore, the present disclosure will not be limited to these embodiments shown herein, but is to be accorded the widest scope consistent with the principles and novel features disclosed herein.

What is claimed is:

1. A method for displaying a picture, comprising:
acquiring a first panoramic picture;
determining a to-be-displayed picture region and a target picture region in the first panoramic picture;
mapping the target picture region to a target planar sub-window;
performing target recognition on the target planar sub-window, and in response to determining that a target object is recognized, placing the target object at a preset position in the target planar sub-window; and
displaying the to-be-displayed picture region and the target planar sub-window on a target display interface.

2. The method according to claim 1, wherein determining the to-be-displayed picture region and the target picture region in the first panoramic picture comprises:
receiving a picture selection instruction, and determining the to-be-displayed picture region and the target picture region in the first panoramic picture according to the picture selection instruction.

3. The method according to claim 1, wherein, before performing target recognition on the target planar sub-window:
at least one operation of adjusting a shooting position, adjusting a shooting angle, or rotating a panoramic camera is performed to place the target object in the target planar sub-window, the target object being recognized in the target planar sub-window.

4. The method according to claim 1, further comprising, after a target object is recognized:
determining first position information of the target object in the first panoramic picture;
determining second position information of the target object in a to-be-displayed panoramic picture, wherein the to-be-displayed panoramic picture comprises a panoramic picture to be displayed after the first panoramic picture; and
when the first position information and the second position information do not meet a preset condition, adjusting a target picture region of the to-be-displayed panoramic picture, the target picture region of the to-be-displayed panoramic picture containing the target object.

5. The method according to claim 4, wherein adjusting the target picture region of the to-be-displayed panoramic picture comprises:
determining a positional offset of the target object between the first panoramic picture and the to-be-displayed panoramic picture based on the first position information and the second position information; and
sliding and adjusting the target picture region of the to-be-displayed panoramic picture based on the positional offset.

6. The method according to claim 4, wherein adjusting the target picture region of the to-be-displayed panoramic picture comprises:
determining an angle offset of the target object between the first panoramic picture and the to-be-displayed panoramic picture based on the first position information and the second position information; and
rotating and adjusting the target picture region of the to-be-displayed panoramic picture based on the angle offset.

7. The method according to claim 4, wherein determining the second position information of the target object in the to-be-displayed panoramic picture comprises:
performing target tracking on the target object based on the first position information to obtain the second position information of the target object in the to-be-displayed panoramic picture.

8. The method according to claim 1, wherein displaying the to-be-displayed picture region and the target planar sub-window on the target display interface comprises:
when the target display interface is a single display interface, centering and displaying the to-be-displayed picture region, and displaying the target planar sub-window at a lower right corner or upper right corner of the target display interface to display the to-be-displayed picture region and the target planar sub-window on the target display interface in a picture-in-picture mode.

9. The method according to claim 1, wherein displaying the to-be-displayed picture region and the target planar sub-window on the target display interface comprises:
displaying the to-be-displayed picture region on a left half of the target display interface, and displaying the target planar sub-window on a right half of the target display interface to display the to-be-displayed picture region and the target planar sub-window on the target display interface in a split-screen mode.

10. The method according to claim 1, wherein displaying the to-be-displayed picture region and the target planar sub-window on the target display interface comprises:
when the target display interface comprises two display interfaces, displaying the to-be-displayed picture region and the target planar sub-window on the two display interfaces respectively.

11. The method according to claim 1, wherein after the to-be-displayed picture region and the target planar sub-window are displayed on the target display interface, the method further comprises:
receiving adjustment information of the target planar sub-window; and
adjusting at least one of a position of the target planar sub-window on the target display interface, a size of the target planar sub-window, or a shape of the target planar sub-window based on the adjustment information.

12. The method according to claim 11, wherein after the to-be-displayed picture region and the target planar sub-window are displayed on the target display interface, the method further comprises:
enhancing a display effect of the target object in the target planar sub-window.

13. The method according to claim 12, wherein enhancing the display effect comprises at least one of:
sharpening processing on the target object in the target planar sub-window; or
bilateral filtering on the target object in the target planar sub-window.

14. A system for picture display, comprising a target display interface, a processor, and a memory coupled to the processor and the target display interface and storing computer instructions that, when executed by the processor, cause the processor to:
acquire a first panoramic picture;
determine a to-be-displayed picture region and a target picture region in the first panoramic picture;
map the target picture region to a target planar sub-window; and
perform target recognition on the target planar sub-window,
wherein:
in response to determining that a target object is recognized, the processor is configured to cause the target display interface to place the target object at a preset position in the target planar sub-window for display; and
the target display interface is further configured to display the to-be-displayed picture region and the target planar sub-window on the target display interface.

15. The system according to claim 14, wherein the processor is further configured to:
receive a picture selection instruction, and determine the to-be-displayed picture region and the target picture region in the first panoramic picture according to the picture selection instruction.

16. The system according to claim 14, wherein, before performing target recognition on the target planar sub-window:
at least one operation of adjusting a shooting position, adjusting a shooting angle, or rotating a panoramic camera is performed to place the target object in the target planar sub-window, the target object being recognized in the target planar sub-window.

17. The system according to claim 14, wherein the processor is further configured to, after a target object is recognized:
determine first position information of the target object in the first panoramic picture;
determine second position information of the target object in a to-be-displayed panoramic picture, wherein the to-be-displayed panoramic picture comprises a panoramic picture to be displayed after the first panoramic picture; and
when the first position information and the second position information do not meet a preset condition, adjust a target picture region of the to-be-displayed panoramic picture, the target picture region of the to-be-displayed panoramic picture containing the target object.

18. The system according to claim 17, wherein the processor is further configured to:
perform target tracking on the target object based on the first position information to obtain the second position information of the target object in the to-be-displayed panoramic picture.

19. The system according to claim 14, wherein the target display interface is further configured to:
in response to determining that the target display interface is a single display interface, center and display the to-be-displayed picture region, and display the target planar sub-window at a lower right corner or upper right corner of the target display interface to display the to-be-displayed picture region and the target planar sub-window on the target display interface in a picture-in-picture mode; or
display the to-be-displayed picture region on a left half of the target display interface, and display the target planar sub-window on a right half of the target display interface to display the to-be-displayed picture region and the target planar sub-window on the target display interface in a split-screen mode.

20. A computer-readable storage medium, storing computer instructions that, when executed by a processor, cause the processor to perform operations comprising:
acquiring a first panoramic picture;
determining a to-be-displayed picture region and a target picture region in the first panoramic picture;
mapping the target picture region to a target planar sub-window;
performing target recognition on the target planar sub-window, and in response to determining that a target object is recognized, causing a target display interface to place the target object at a preset position in the target planar sub-window for display; and
causing the target display interface to display the to-be-displayed picture region and the target planar sub-window on the target display interface.
